(19) United States
(12) Patent Application Publication
(10) Pub. No.: US 2017/0063880 A1
(43) Pub. Date: Mar. 2, 2017

(54) METHODS, SYSTEMS, AND COMPUTER READABLE MEDIA FOR CONDUCTING MALICIOUS MESSAGE DETECTION WITHOUT REVEALING MESSAGE CONTENT

(71) Applicant: Oracle International Corporation, Redwood Shores, CA (US)

(72) Inventor: Edwin Earl Freed, Claremont, CA (US)

(21) Appl. No.: 14/797,052

(22) Filed: Jul. 10, 2015

(51) Int. Cl. H04L 29/06; H04L 9/32

(52) U.S. Cl. CPC H04L 63/1408; H04L 9/3242; H04L 63/1441; H04L 63/0428

(57) ABSTRACT

Methods, systems, and computer readable media for managing order processing and fallout are disclosed. One exemplary method includes receiving a message object and segmenting the received message object into structural data segments and textual data segments. The method further includes utilizing a keyed cryptographic hash function and the textual data segments to generate corresponding hashed textual data segments, creating a new message object including the structural data segments and the hashed textual data segments, and sending the new message object in lieu of the received message object to a message scanning entity for evaluation.

### TECHNICAL FIELD

The subject matter described herein relates to the encryption and scanning of electronic messages for malicious content. More particularly, the subject matter described herein relates to methods, systems, and computer readable media for conducting malicious message detection without revealing message content.

### BACKGROUND

Recent revelations of eavesdropping on email communications by various entities have compelled a renewed interest in the use of message encryption. Notably, a significant increase in the use of Secure Sockets Layer/Transport Layer Security (SSL/TLS) to protect messages in transit has been experienced. There has similarly been renewed interest by network operators to employ end-to-end protection, rather than hop-by-hop protection, utilizing protocols like Secure/Multipurpose Internet Mail Extensions (S/MIME) and Pretty Good Privacy (PGP). However, the use of such protocols has created unexpected obstacles pertaining to the present nature of email communications as well as the network infrastructure itself. More specifically, i) a significant portion of all communicated email constitutes spam and ii) spam filtering is usually performed by deploying filtering solutions at the “edges” of administrative domains (i.e., positioning the filtering entity as close to the source of the email as possible). The email filtering process typically involves examination of external characteristics of each message (e.g., the Internet protocol (IP) address of the sending client) as well as deep inspection of the message content (e.g., inspection of the message content for certain keywords and/or Universal Resource Locators (URLs) that are known to be indicators of spam). This approach is commonly preferred since the earlier an email message can be discarded as spam, the fewer resources the network ultimately consumes to process it.

However, widespread use of S/MIME, PGP, or any similar scheme unavoidably compromises any filtering that depends on examination of message content the ultimate goal of utilizing such mechanisms is to protect the message content from eavesdroppers. Potential solutions of sharing decryption keys necessary to decrypt the content with the service provider performing the scanning/filtering may also be impracticable since decryption keys may be susceptible to seizure from the service provider without an end user's knowledge or consent. Consequently, there is no general solution to the fundamental dilemma presented, i.e., message content is exposed and analyzed by a scanning entity or the message content is concealed at the expense of not being analyzed by the scanning entity. Notably, both alternatives present practical disadvantages to service providers and customers alike.

Accordingly, there exists a need for systems, methods, and computer readable media for conducting malicious message detection without revealing message content.

### SUMMARY

Methods, systems, and computer readable media for conducting malicious message detection without revealing message content are disclosed. According to one exemplary method, the method includes receiving a message object and segmenting the received message object into structural data segments and textual data segments. The method further includes utilizing a keyed cryptographic hash function and the textual data segments to generate corresponding hashed textual data segments, creating a new message object including the structural data segments and the hashed textual data segments, and sending the new message object in lieu of the received message object to a message scanning entity for evaluation.

According to one exemplary system, the system includes at least one processor, a memory, and a message reconstruction module that is stored in the memory and when executed by the at least one processor is configured to receive a message object, to segment the received message object into structural data segments and textual data segments, to utilize a keyed cryptographic hash function and the textual data segments to generate corresponding hashed textual data segments, to create a new message object including the structural data segments and the hashed textual data segments, and to send the new message object in lieu of the received message object to a message scanning entity for evaluation.

The subject matter described herein may be implemented in hardware, software, firmware, or any combination thereof. As such, the terms “function” or “module” as used herein refer to hardware, software and/or firmware components for implementing the feature(s) being described. In one exemplary implementation, the subject matter described herein may be implemented using a non-transitory computer readable medium having stored thereon computer executable instructions that when executed by the processor of a computer cause the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms. For example, in one exemplary embodiment, a non-transitory computer readable medium having stored thereon executable instructions that when executed by a processor of a computer cause the computer to perform steps comprising receiving a message object, segmenting the received message object into structural data segments and textual data segments, utilizing a keyed cryptographic hash function and the textual data segments to generate corresponding hashed textual data segments, creating a new message object including the structural data segments and the hashed textual data segments, and sending the new message object in lieu of the received message object to a message scanning entity for evaluation.

### BRIEF DESCRIPTION OF THE DRAWINGS

The subject matter described herein will now be explained with reference to the accompanying drawings of which:

FIG. 1 is a block diagram illustrating an exemplary system for conducting malicious message detection without revealing message content according to an example of the subject matter described herein;

FIG. 2 is a block diagram illustrating exemplary tuple table according to an example of the subject matter described herein;

FIG. 3 is a flow chart illustrating an exemplary method for conducting malicious message detection without revealing message content according to an example of the subject matter described herein; and

FIG. 4 is a flow chart illustrating an exemplary method for utilizing a hash function to generate hashed textual data segments according to an example of the subject matter described herein; and

FIG. 5 depicts a flow diagram of an exemplary method 500 for reconstructing a message object returned from a scanning entity according to an example of the subject matter described herein.

### DETAILED DESCRIPTION

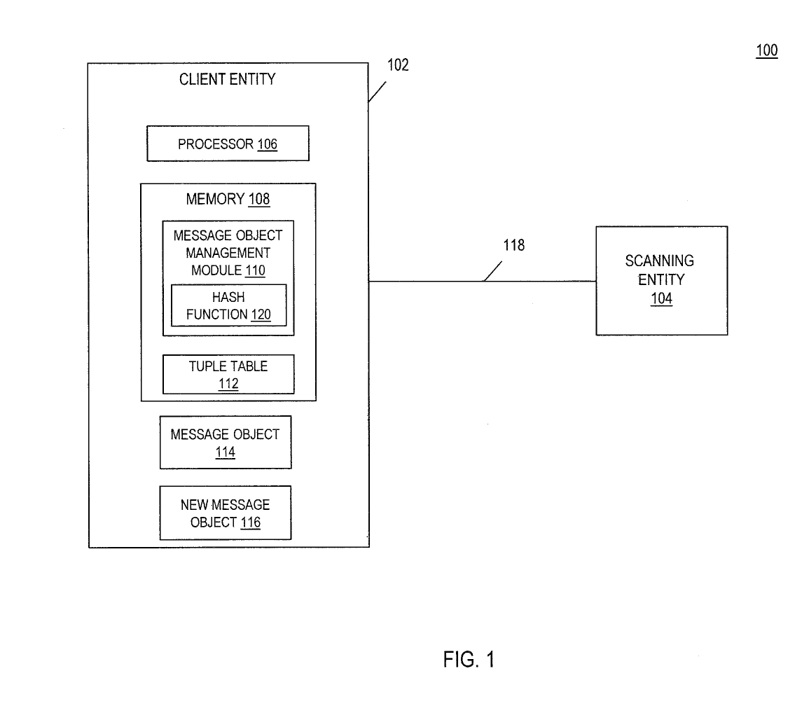

The subject matter described herein relates to methods, systems, and computer readable media for conducting malicious message detection without revealing message content. FIG. 1 is a block diagram illustrating an exemplary architecture for a malicious message detection system 100 according to an example of the subject matter described herein. Referring to FIG. 1, system 100 may include a client entity 102 and a scanning entity 104. In some embodiments, client entity 102 and scanning entity 104 may be communicatively connected via an established secure channel 118. For example, secure channel 118 may include a direct connection or a connection established via a communications network (e.g., the Internet). In some embodiments, scanning entity 104 may be a specialized network element or machine operated by a central content scanning (CCS) facility. For example, scanning entity 104 may be embodied as a computer server machine configured to conduct scanning tasks on message objects (e.g., email messages, HTML-based messages, etc.) received from client entity 102. Although only one client entity 102 and only one scanning entity 104 are shown in FIG. 1, additional client entities and scanning entities may be employed in system 100 without departing from the scope of the present subject matter.

In some embodiments, client entity 102 may comprise a special purpose computer device or machine that includes hardware components (e.g., one or more processor units, memory, and network interfaces) configured to execute software elements (e.g., applications, cartridges, modules, etc.) for the purposes of performing one or more aspects of the disclosed subject matter herein. For example, client entity 102 may include a processor 106 and memory 108 that are used to execute a message object management module 104 (which is stored in memory 108).

In some embodiments, client machine 102 may comprise a special purpose machine that includes a processor 106 (which may be operatively coupled to a bus) for processing information and executing instructions or operations. Processor 106 may be any type of processor, such as a central processing unit (CPU), a microprocessor, a multi-core processor, and the like. Client entity 102 further includes a memory 108 for storing information and instructions to be executed by processor 106. In some embodiments, memory 108 may comprise one or more of random access memory (RAM), read only memory (ROM), static storage such as a magnetic or optical disk, or any other type of machine or non-transitory computer-readable medium. Client entity 102 may further include a communication device (not shown), such as a network interface card or other communications interface, configured to communicate with scanning entity 104. In some embodiments, memory 108 may be utilized to store message object management module 110 and a plurality of stored tuples, which may be represented as a tuple table 112. Upon its execution, message object management module 104 may generate a tuple table 112 which may also be stored in memory 108.

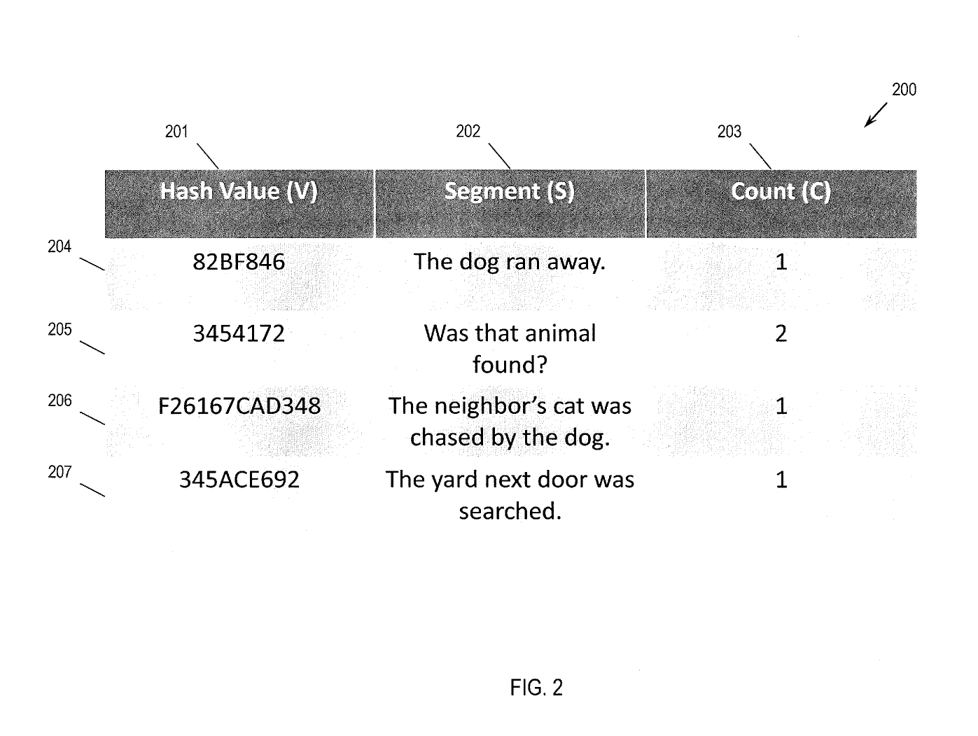

Upon receiving a message object 114, such as an email message and/or an HTML based message (e.g., a message with HTML content), from a sending entity (not shown), client entity 102 may initiate and/or execute message object management module 110. Upon initiation, message object management module 110 made generate and/or initialize tuple table 112. In some embodiments, tuple table 112 may include a relational database structure that includes 3-tuple entries containing associated hash value elements, segment content elements, and count value elements (as described in greater detail below and in FIG. 2). In some embodiments, tuple table 112 is generated and utilized on a per message object basis.

In some embodiments, message object management module 110 may also be configured to initiate the creation of a random key value. For example, message object management module 110 may create a one-time random key (e.g., random key “K”) that will be used as input in a hash function 120. In some embodiments, the generated random key value may a binary or hexadecimal value. Although FIG. 1 depicts a single hash function 120 associated with message object management module 110, any number of hash functions may be accessible by or included within message object management module 110 without departing from the scope of the present subject matter. In some embodiments, hash function 120 may comprise a keyed cryptographic hash function (e.g., an HMAC-SHA-1 hash function).

Once tuple table 112 is initialized and the random key is generated, the original message object 114 is scanned and subsequently segmented by message object management module 110. For example, the content of message object 114 may be segmented into one of a plurality of message content categories. For example, a first message content category may include structural content data comprising the message object's structural and presentation information, such as hypertext markup language (HTML) tags, scripts, and the like. Similarly, a second message content category may include textual content data comprising the message object's alphanumeric text information. Lastly, a third message content category may include links to external content, which may ultimately be processed as structural content data or textual content data.

After the message object segmented classified into the three categories, message object management module 110 may initiate the creation of a new message object 116. For example, message object management module 110 may copy structure data segments (i.e., structural content data that has been segmented) into the new output message without any changes or modifications. For example, HTML tags in the original message object 114 are left alone (e.g., not hashed or encrypted). Notably, these HTML tags are ultimately scanned by scanning entity 104 upon its receiving of new message object 116.

Once the identified structural data segments are processed (e.g., identified and copied to message object 116), message object management module 110 may process the textual data segments (i.e., textual content data that has been segmented). In some embodiments, each textual data segment is run through hash function 120. Specifically, using random key K and textual data segments as inputs for hash function 120, a hash value V may be produced. As an example, hash value V may be determined via V=H(S, K), where H represents a hash function, S represents a textual data segment, and K represents the random key. Upon being generated, hash value V is subsequently compared to each of the entries in tuple table 112. If no entry containing the hash value is found, a 3-tuple containing i) the hash value, ii) the textual data segment, and iii) a count value is added to the table 112. In addition, the hash value (i.e., a hashed textual data segment) is also used to replace the original message object content S (i.e., the textual data segment) in the new message object 116.

In the event the hash value V is found in an entry of tuple table 112, the associated count value element “C” is accessed and retrieved by message object management module 110. Message object management module 110 may subsequently increment and update the count value in table 110 (e.g., add one (1) to the existing count value in the table entry). Message object management module 110 may then be configured to rehash the hash value V by the number of time indicated by the count value element (C) in the stored tuple entry (e.g., “C” times) to produce a new hash value W (i.e., a hashed textual data segment). In some embodiments, hash value W is stored as a portion of a new 3-tuple entry (e.g., (W,S,0)) in tuple table 112. Furthermore, the new hashed textual data segment (i.e., hash value W) may be used to replace textual data segment S in new message object 116 being generated by message object management module 110. Notably, this processing is conducted for each textual data segment to be considered for inclusion in new message object 116.

In some embodiments, message object management module 110 may process external content link data segments (i.e., external content link information that has been segmented). Notably, message object management module 110 may be configured to process external content link data in the heuristic manner. In some embodiments, client entity 102 may be configured to assess the extent or how much of a URL can be revealed to scanning entity 104. Utilizing criteria client entity 102 deems appropriate, message object management module 110 may designate and/or segment the URL into structural data segments or textual data segments. In some embodiments, module 110 may access a whitelist or a blacklist to determine whether to process the external content link data in a manner similar to the structural data segments or the textual data segments. In some embodiments, the whitelist and/or blacklist may include listings of URLs and/or URL patterns. Similarly, the whitelist and/or blacklist may include entries, each of which may be based on the underlying IP address to which an associated URL can be resolved. For example, an internal IP address may be predefined as safe and thereby included in a whitelist. Conversely, an external IP address may always require some level of scanning, and thus may be designated to be included in a blacklist. After conducting such a designation, message object management module 110 can subsequently process an external content link data segment in the manner described above with respect to structural data segment processing or textual data segment processing.

In some embodiments, message object management module 110 may determine that the entire URL contained in the external content link data segment may need to be hidden from scanning entity 104. Consequently, message object management module 110 may be configured to treat the URL as a textual data segment and, thus, hash the entire external content link data segment accordingly. In some alternate embodiments, the possibility of permitting malicious content to exist in the message object trumps all other considerations thereby requiring the external content link data segment to be revealed in its entirety to scanning entity 104 (i.e., the external content link data segment is classified by message object management module 110 as a structure data segment). In some instances, message object management module 110 may allow the hostname to be revealed but conceal the remainder of the URL.

It will be appreciated that client entity 102 and/or functionality described herein may constitute a special purpose computer. Further, it will be appreciated that client entity 102 and/or functionality described herein can improve the technological field pertaining to cryptographic systems by providing mechanisms for selectively encrypting message objects to be processed in an end-to-end system. Notably, the utilization of the present subject matter will enable end-to-end protection schemes to be utilized on a larger scale.

It will be appreciated that FIG. 1 is for illustrative purposes and that various elements, their locations, and/or their functions described above in relation to FIG. 1 may be changed, altered, added, or removed. For example, some nodes and/or functions may be combined into one entity as shown in FIG. 1 or distributed among a plurality of entities/devices.

FIG. 2 is a diagram illustrating an exemplary tuple table 200 (not unlike table 112 depicted in FIG. 1) that may be generated and utilized by a message object management module (e.g., message object management module 110 depicted in FIG. 1). Specifically, FIG. 2 depicts a logical illustration of a tuple table 200 comprising three category columns 201-203. Specifically, tuple table 200 comprises a hash value column 201, a segment value column 202, and a count value column 203. Further, tuple table 200 may include rows 204-207, each of which contains a 3-tuple entry (V,S,C). For example, entry 204 includes an entry that includes i) a hash value of 82BF846, ii) a segment S comprising “The dog ran away”, and iii) a count value (C) of 0. For example, message object management module 110 (shown in FIG. 1) may be configured to access and inspect each of entries 204-207 to compare the recorded entry hash values (e.g., value in column 201) with the generated hash value. If a matching entry is found, then the count value for that entry in column 203 is incremented by 1 and the hash value is rehashed by the message object management module for a predefined number of times (e.g., C+1 times). If a matching entry is not found, a new entry including the unrecognized hash value, the associated textual data segment, and initial count value (i.e., equal to zero) is added to the table (e.g., inserting/adding an entry to table 200 directly beneath entry 207) by the message object management module.

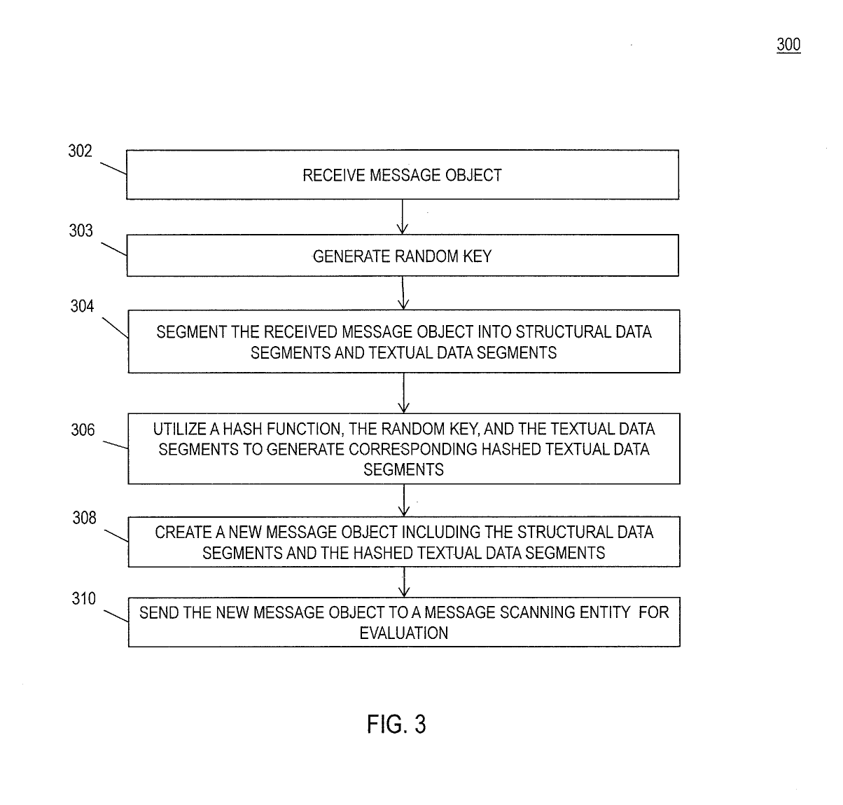

FIG. 3 is a flow chart illustrating an exemplary process 300 for conducting malicious message detection without revealing message content according to an example of the subject matter described herein. For illustrative purposes and explanation, references to entities included in FIGS. 1 and 2 may be used below. In some embodiments, exemplary process 300, or portions thereof, may be performed by or at client entity 102, and/or another node, module, or entity. In some embodiments, exemplary process 300 may include steps 302, 303, 304, 306, 308, and/or 310.

At step 302, a message object is received. In some embodiments, a client entity receives an email message object containing HTML tags and scripts. Upon receiving the message object, the client entity is configured to initiate a process to generate a new message object, i.e., as opposed to filtering the original message object received by the client entity. For example, one exemplary message object received by client entity 102 may be depicted as follows:

```
<html>
  <head>
      <script src=″http://evildoersofevil.net″/>
  </head>
  <body>
        <p>This is a sample message.</p>
        <p>Here is some <b>bold</b> text.</p>
        <p>Here is some <b>bold text</b>, followed by an image.</p>
      <img src=″http://stockphoto.com/one-of-millions-of-stock-images.
      jpg″/>
    </body>
</html>
```

At step 303, a random key value is generated. In some embodiments, a one time random key “K” is created by client entity 102.

At step 304, the message object is segmented. In some embodiments, the message object is segmented into at least structural data segments and textual data segments. In some alternate embodiments, the message object may also be segmented into external content link data segments. For example, the portions of the original message object may be segmented into structural data segments that comprise structural and presentation data and textual data segments that comprise textual content data. In some embodiments, the structural data segments may include HTML data, tag data, script data, and links to external scripts. For example, HTML tags in the message object presented above, such as <html>, <head>, <body>, <p>, <image src=>, <script src=>, <b>, </html>, </head>, </body>, </p>, </image src=>, </script src=>, </b> and the like, may be classified as structural content data and are left unchanged by message object management module 110.

Likewise, the textual content data of the original message object 114 displayed above is segmented into groups of text such as such as “This is a sample message” and “Here is some bold text”. In some embodiments, a particular message object segment maybe designated and/or defined by surrounding HTML tags. In some alternative embodiments, the original message object 114 may also be segmented in accordance to a third content category that includes external content link data segments.

At step 306, a hash function, the random key, and the textual data segments are utilized to generate corresponding hashed textual data segments. For example, the aforementioned example textual content, such as “This is a sample message”, “Here is some bold text” and the like, are subjected to a hash function (e.g., an hmac-sha-1 hash function) utilized by message object management module 110 to produce a hash value. In some embodiments, the hash function receives a textual data segment and a random key value generated by the message object management module as inputs and, accordingly, generates a hash value. The generated hash value may be represented as a hexadecimal value, which may be used as replacement content for a new message object (see below). For example, the textual content data comprising “This is a sample message” may be converted to a hexadecimal value equal to “{AF72D482C0C0141F1B95C8F162418D89FE85A EA9}” and the textual content data comprising “Here is some bold text” may be converted to a hexadecimal value equal to {D017D28E55E7F2662F61ED3FC4 D94D1450B7D022}<b>{92F1110566B2F44355F0474310FB7770B86164D4}</b>{3DAAB5E39BC0D10B45A6B4E9A14F6CBA8BC2439A}.

In some alternative embodiments, message object management module 110 may further assess any external links (e.g., links to external content) contained in the message object in order to determine what message content is to be revealed to a scanner entity (e.g., scanning entity 104). For example, using the example message object presented above, the external link <script src=“http://evildoersofevil.net”/> may be left unchanged since the link only includes the domain address. However, the external link of <img src=“http://stockphoto.com/one-of-millions-of-stock-images.jpg”/> may be converted to <img src=“http://stockphoto.com/{BA702481A892055BF40058BB 49E66EB5DFA4D645}”/> since message object management module 110 may be configured to disregard the domain portion of the image's URL, but determine (based on configuration) that the filename included in the link data is to be hashed using a hash function.

At step 308, a new message object is created. In some embodiments, message object management module 110 generates a new message object 116 that includes the structural data segments (i.e., unchanged and unmodified as compared to the original message object) and the hashed textual data segments. For example, message object management module 110 may be configured to construct new message object 116 by copying the identified structural data segments from the originally received message object 114. Likewise, message object management module 110 may be configured to utilize the rehashed textual data segments in the new message object 116 as replacements for all of the previously identified textual data segments in the original message object 114. In some alternate embodiments, the external link data segments may also be processed by the message object management module 110.

At step 310, the new message object is sent to scanning entity. In some embodiments, once the creation of a new message object (e.g., an email message object) is completed, the new message object is sent by the client entity over a secure channel to a central content scanning facility for scanning. Namely, the new message object is sent to a message scanning entity for evaluation in lieu of the received message object. For example, the new message object constructed in step 308 may be represented as:

```
<html>
  <head>
    <script src=″http://evildoersofevil.net″/>
  </head>
  <body>
    <p>{AF72D482C0C0141F1B95C8F162418D89FE85AEA9}</p>
    <p>{D017D28E55E7F2662F61ED3FC4D94D1450B7D022}<b>{92F1
    110566B2F44355FD474310FB7770B86164D4}</b>{3DAAB5E39BC
    0D10B45A6B4E9A14F6CBA8BC2439A}</p>
    <p>{3F1AF00F938C8B5BD86B2E30059DD0B48273E6D6}<b>{367E
    B67F45FEBF8A54EEC5C7C8662E22B42936F2}</b>{4CC16E64104
    B4572DF146BCAD4765D56F35321A6}</p>
    <img src=″http://stockphoto.com/{BA702481A892055BF4
      0058BB49E66EB5DFA4D645}″/>
  </body>
</html>
```

Upon receipt of this message object sent by client entity 102, the scanning entity may conduct its analysis. More specifically, scanning entity 104 may be configured to i) approve/designate the received message object as ‘complete’, ii) detect a problem and reject the message object in its entirety, or iii) return a modified message object to the sending client entity with the problematic content material removed. In the even the latter case transpires, the client entity may subsequently utilize the value-content-count tuple table (e.g., table 112) to replace the hash value included in the returned message object with the corresponding original content data. Client entity 102 may then present/display that flagged content to a user and/or resubmit the message object with the content unencrypted to scanning entity 104 for a follow-up inspection.

It will also be appreciated that exemplary process 300 is for illustrative purposes and that different and/or additional actions may be used. It will also be appreciated that various actions associated with exemplary process 300 may occur in a different order or sequence.

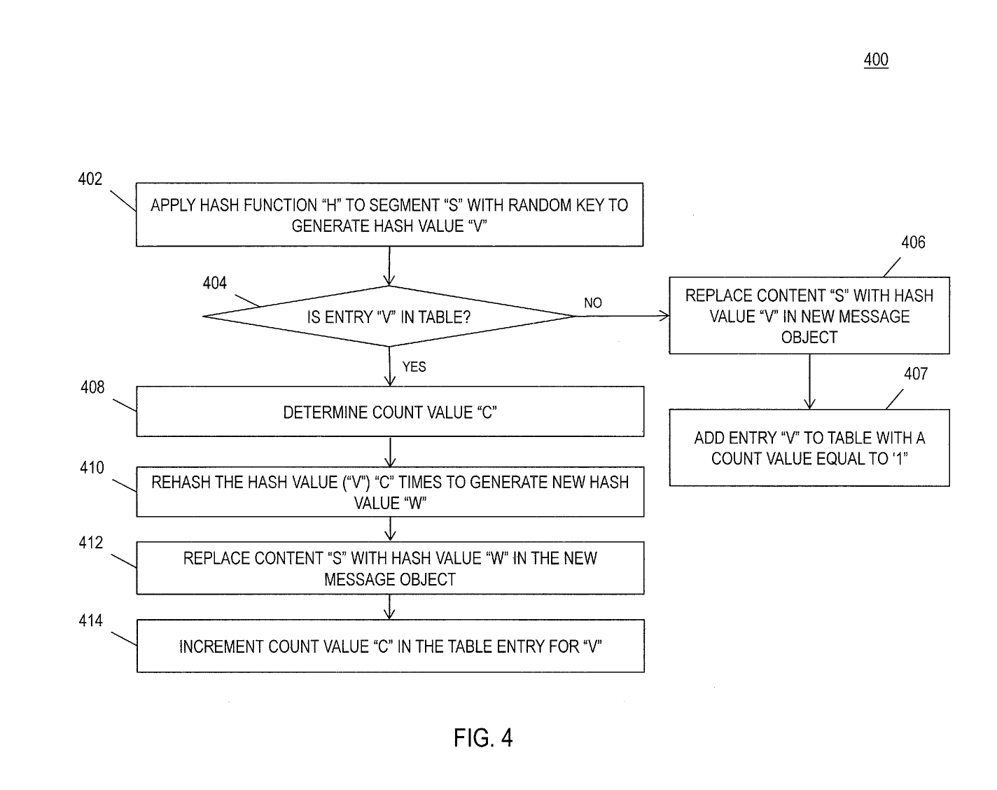

FIG. 4 depicts a flow diagram of an exemplary method 400 for utilizing the keyed cryptographic hash function according to an example of the subject matter described herein. For illustrative purposes and explanation, references to entities included in FIGS. 1-3 may be used below. In some embodiments, exemplary process 400, or portions thereof, may be performed by or at client entity 102, and/or another node, module, or entity. In some embodiments, exemplary process 400 may include steps 402, 404, 406, 408, 410 and/or 412. In some embodiments, method 400 may represent an exemplary embodiment representing sub-steps of step 306 described above with respect to FIG. 3. Notably, method 400 depicts one embodiment in which step 306 may be performed and is not intended to limit the scope of the present subject matter or step 306 depicted in FIG. 3.

In step 402, a hash function “H” is applied to a textual data segment “S” with a random key. In some embodiments, a textual data segment and a random key are provided to a hash function as inputs. Consequently, a hash value “V” is generated. In some embodiments, the hash function may be a HMAC-SHA-A hash function. In some embodiments, the message object management module is configured to create the one-time random key, K. For example, the random key may comprise the hexadecimal representation of “2CC6C49C4C888CA5BA1A001AEE8674C08E799CD5”.

In step 406, a determination is made as to whether an entry in the tuple table contains the value “V”. In some embodiments, message object management module initialize a tuple table configured to store 3-tuples comprising [hash value (V)-segment content (S)-count value (C)] data. If the tuple table does not contain value “V”, then method 400 continues to step 406 in which hash value V is stored as an entry in the tuple table and content segment “S” is replaced with hash value “V” in a new message object being generated by the message object management module. The method 400 then continues to step 407 where a 3-tuple containing “V”, segment “S”, and a count value “C” equal to one (1) is added as an entry to the tuple table. Returning to step 404, if the table does contain hash value “V”, then method 400 continues to step 408.

In step 408, a count value is determined. In some embodiments, message object management module accesses the tuple table to access a count value “C” corresponding to the entry containing the hash value “V”.

In step 410, the hash value V is rehashed to generate a new hash value “W”. In some embodiments, the message object management module rehashes the existing hash value V for that amount/number of times (i.e., C+1) in order to derive a new hash value “W”.

In step 412, textual data segment “S” is replaced with new has value “W” in the new message object. In some embodiments, the message object management module is configured for replacing content segment “S” with hash value “W” in a new message object being generated. In addition, a new tuple entry including new hash value “W” is stored in the tuple table. For example, message object management module generates a new 3-tuple comprising hash value W, the original textual data segment S, and a count value equal to zero (0) and subsequently records this new tuple in the tuple table.

In step 414, the count value determined in step 408 is incremented in the tuple table entry containing “V” by a value of one (e.g., the new count value for the tuple entry equals “C+1”).

After completely processing the textual data segment “S” introduced in step 402, method 400 may be repeated for the next textual data segment of the message object to be processed.

It will also be appreciated that exemplary process 400 is for illustrative purposes and that different and/or additional actions may be used. It will also be appreciated that various actions associated with exemplary process 400 may occur in a different order or sequence.

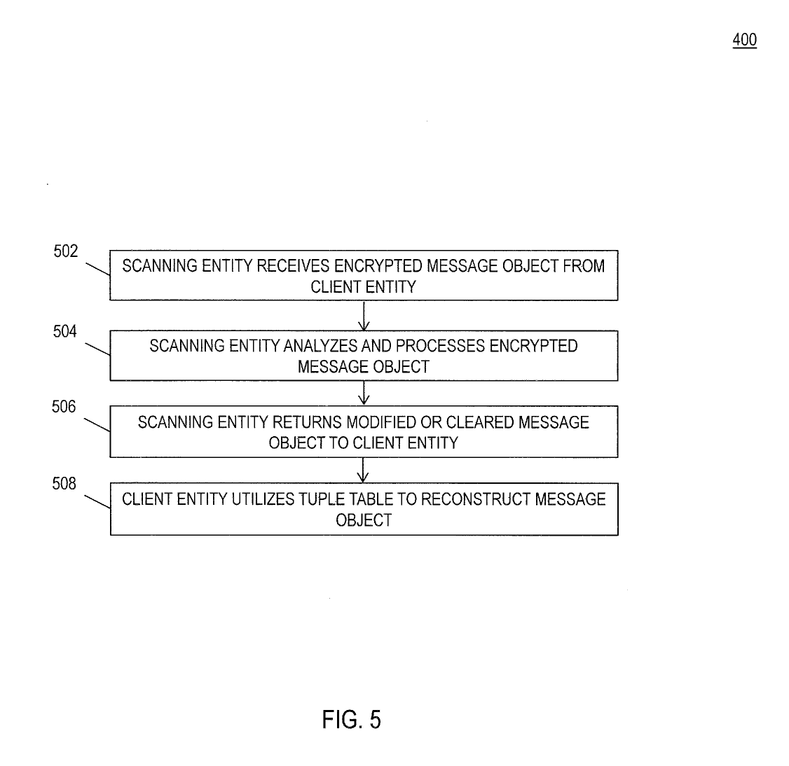

FIG. 5 depicts a flow diagram of an exemplary method 500 for reconstructing a message object returned from a scanning entity according to an example of the subject matter described herein. For illustrative purposes and explanation, references to entities included in FIGS. 1 and 2 may be used below. After the new encrypted message object is generated by client entity 102, client entity 102 sends the encrypted message object to scanning entity 104 (step 502) via the previously established secure channel 118. Upon receipt of the new message object, scanning entity 104 conducts its central scanning duties by analyzing and processing the message object (step 504). In some embodiments, scanning entity 114 may modify the structure of the message object to make it safe. For example, scanning entity 104 can i) clear the new message object as complete, ii) condemn the new message object outright, or iii) return a modified message object to client entity 102 with any identified problematic content material removed. After processing the message object accordingly, scanning entity 104 may return the modified (or cleared) message object to client entity 102 (step 506). Upon receiving the message object, client entity 102 may reconstruct the original message object by looking up each hash value in the tuple table and inserting the original text (step 508). For example, client entity 102 may utilize the hash-content-count table (e.g., tuple table 200 in FIG. 2) to replace the hash value in the returned message object with the original content segment, which is subsequently displayed to a user (e.g., intended recipient of message object).

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method comprising:
receiving a message object;
segmenting the received message object into structural data segments and textual data segments;
utilizing a keyed cryptographic hash function and the textual data segments to generate corresponding hashed textual data segments;
creating a new message object including the structural data segments and the hashed textual data segments; and
sending the new message object in lieu of the received message object to a message scanning entity for evaluation.

2. The method of claim 1 wherein segmenting the received message object includes segmenting the received message object into the structural data segments, the textual data segments, and external content link data segments.

3. The method of claim 2 comprises accessing a whitelist or a blacklist to determine whether to process the external content link data in a manner similar to the structural data segments or the textual data segments.

4. The method of claim 1 wherein hashing the textual data segments includes:
generating a random key value;
applying, for each of the textual data segments, a single textual data segment and the random key value to a hash function to generate a hash value; and
determining if the hash value exists as an element in any of a plurality of stored tuples associated with the received message object.

5. The method of claim 4 comprising, in the event the hash value is determined to not be an element in any of the plurality of stored tuples, creating a tuple entry including the hash value, the single textual data segment, and a count value into the tuple table and replacing the single textual data segment with the hash value in the new message object.

6. The method of claim 4 comprises, in the event the hash value is determined to be an element in one of the plurality of stored tuples, rehashing the hash value by a number of times indicated by a count value element contained in the one of the plurality of stored tuples to produce a new hash value and replacing the single textual data segment with the new hash value in the new message object.

7. The method of claim 1 wherein the message object includes HTML content.

8. A system comprising:
at least one processor;
a memory; and
a message object management module that is stored in the memory and when executed by the at least one processor is configured to receive a message object, to segment the received message object into structural data segments and textual data segments, to utilize a keyed cryptographic hash function and the textual data segments to generate corresponding hashed textual data segments, to create a new message object including the structural data segments and the hashed textual data segments, and to send the new message object in lieu of the received message object to a message scanning entity for evaluation.

9. The system of claim 8 wherein the message object management module is further configured to segment the received message object into the structural data segments, the textual data segments, and external content link data segments.

10. The system of claim 9 wherein the message object management module is further configured to access a whitelist or a blacklist to determine whether to process the external content link data in a manner similar to the structural data segments or the textual data segments.

11. The system of claim 8 wherein the message object management module is further configured to:
generate a random key value;
apply, for each of the textual data segments, a single textual data segment and the random key value to a hash function to generate a hash value; and
determine if the hash value exists as an element in any of a plurality of stored tuples associated with the received message object.

12. The system of claim 11 wherein the message object management module is further configured to, in the event the hash value is determined to not be an element in any of the plurality of stored tuples, create a tuple entry including the hash value, the single textual data segment, and a count value into the tuple table and replacing the single textual data segment with the hash value in the new message object.

13. The system of claim 11 the message object management module is further configured to, in the event the hash value is determined to be an element in on of the plurality of stored tuples, rehash the hash value by a number of times indicated by a count value element contained in the one of the plurality of stored tuples to produce a new hash value and replacing the single textual data segment with the new hash value in the new message object.

14. The system of claim 8 wherein the message object includes HTML content.

15. A non-transitory computer readable medium having stored thereon executable instructions that when executed by a processor of a computer cause the computer to perform steps comprising:
receiving a message object;
segmenting the received message object into structural data segments and textual data segments;
utilizing a keyed cryptographic hash function and the textual data segments to generate corresponding hashed textual data segments;
creating a new message object including the structural data segments and the hashed textual data segments; and
sending the new message object in lieu of the received message object to a message scanning entity for evaluation.

16. The computer readable medium of claim 15 wherein segmenting the received message object includes segmenting the received message object into the structural data segments, the textual data segments, and external content link data segments.

17. The computer readable medium of claim 16 comprises accessing a whitelist or a blacklist to determine whether to process the external content link data in a manner similar to the structural data segments or the textual data segments.

18. The computer readable medium of claim 15 wherein hashing the textual data segments includes:
generating a random key value;
applying, for each of the textual data segments, a single textual data segment and the random key value to a hash function to generate a hash value; and
determining if the hash value exists as an element in any of a plurality of stored tuples associated with the received message object.

19. The computer readable medium of claim 18 comprising, in the event the hash value is determined to not be an element in any of the plurality of stored tuples, creating a tuple entry including the hash value, the single textual data segment, and a count value into the tuple table and replacing the single textual data segment with the hash value in the new message object.

20. The computer readable medium of claim 18 comprises, in the event the hash value is determined to be an element in one of the plurality of stored tuples, rehashing the hash value by a number of times indicated by a count value element contained in the one of the plurality of store tuples to produce a new hash value and replacing the single textual data segment with the new hash value in the new message object.
